(19) United States
(12) Patent Application Publication
(10) Pub. No.: US 2010/0265376 A1
(43) Pub. Date: Oct. 21, 2010

(54) SEMICONDUCTOR IMAGE DEVICE

(75) Inventor: YOSHIZUMI HARAGUCHI, KANAGAWA (JP)

Correspondence Address: YOUNG & THOMPSON, 209 Madison Street, Suite 500, Alexandria, VA, 22314, US

(73) Assignee: NEC ELECTRONICS CORPORATION, KANAGAWA (JP)

(21) Appl. No.: 12/728,330

(22) Filed: Mar. 22, 2010

(30) Foreign Application Priority Data
Apr. 17, 2009 (JP) 2009-100842

(51) Int. Cl. H04N 5/335

(52) U.S. Cl. 348/311; 348/E05.031

(57) ABSTRACT

A line sensor includes a second conductive type semiconductor substrate where a first conductive type well region is formed, a pixel line formed in the well region, a plurality of pixels being formed on the well region, the plurality of pixels generating charges corresponding to an incident light, a CCD register unit formed on the well region, a transfer electrode being arranged on the well region, the transfer electrode transferring the charges in response to a transfer clock, an output circuit which outputs a voltage signal corresponding to the charges transferred by the transfer electrode, a wiring part which supplies a reference potential to the well region and the output circuit, and a resistor which is included in a wiring, the wiring connecting a first contact between the well region and the wiring part to a second contact between the output circuit and the wiring part.

### INCORPORATION BY REFERENCE

This application is based upon and claims the benefit of priority from Japanese patent application No. 2009-100842, filed on Apr. 17, 2009, the disclosure of which is incorporated herein in its entirety by reference.

### BACKGROUND

1. Field of the Invention

The present invention relates to a semiconductor image device, and more particularly, to a semiconductor image device having a charge transfer mechanism by a transfer clock.

2. Description of Related Art

A black and white or color photocopier uses a line sensor as an image acquire part. A CCD (Charge Coupled Device) image element having a plurality of pixel lines is widely used as a line sensor. For example, a CCD image element having 7500 pixels×three channels is used as a line sensor. These CCD image elements supply transfer clocks of opposite phases to two transfer gates, and transfer charge till a charge voltage conversion unit.

In the CCD image element, a strain may occur in a reference voltage inside a device with respect to a reference voltage of a package external terminal according to couplings of a few hundred pF between a transfer clock and a reference voltage. Because capacity formed between the transfer gate and reference voltage of a device reaches about a few hundred pF, and there is an inductance component of a bonding wire connecting a device with a package and a lead frame between an electrode pad which supplies reference voltage (GND) of a device and an external terminal of a package. In the case where a strain occurs in the reference voltage inside a device with respect to a reference voltage of a package external terminal, a strain also occurs in an output signal that an inside of a device is a reference level, thereby causing degradation of signals.

Incidentally, when noise elements generated by hot carrier flow in a signal charge accumulation part or a signal charge transfer unit from a MOS transistor configuring an output circuit, dark signal output or unevenness of dark signal output is generated. A technique of reducing dark signal output or unevenness of dark signal output is disclosed in Japanese Unexamined Patent Application Publication No. 6-275811. A technique that controls interference of noise between analog and digital and manufactures high integration semiconductor integrated circuit inexpensively is disclosed in Japanese Unexamined Patent Application Publication No. 2000-31381.

### SUMMARY

Transfer clocks having a different phase from each other are supplied to two transfer gates provided in a CCD image element. However, each transfer clock may not be supplied to each transfer gate in an intended timing due to an influence of above cited inductance. Further, output signal waveform may have strain corresponding to a phase shifting between these transfer clocks. Thus there is a problem that output signal waveform has strain corresponding to a phase shifting between the transfer clocks.

According to an embodiment of the present invention, there is provided a semiconductor image device including a second conductive type semiconductor substrate, a pixel arranged region, a transfer electrode arranged region, an output circuit, a wiring part and a resistor.

A first conductive type well region is formed in the semiconductor substrate. A pixel arranged region is formed in the well region. A plurality of pixels are formed on the well region. The plurality of pixels generate charges corresponding to an incident light. The transfer electrode arranged region is formed on the well region. A transfer electrode is arranged on the well region. The transfer electrode transfers the charges in response to a transfer clock. The output circuit outputs a voltage signal corresponding to the charges transferred by the transfer electrode. The wiring part supplies a reference potential to the well region and the output circuit. The resistor is included in a wiring, the wiring connecting a first contact between the well region and the wiring part to a second contact between the output circuit and the wiring part.

The resistor and the wiring unit make it possible to further reduce generation of a strain of output signal waveform corresponding to a phase shifting between the transfer clocks compare with the conventional semiconductor image device.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a top plane pattern diagram showing a line sensor of a first exemplary embodiment of the present invention;

FIG. 2 is a part of a top plane pattern diagram showing the line sensor of the first exemplary embodiment of the present invention;

FIG. 3 is a part of cross-sectional diagram showing the line sensor of the first exemplary embodiment of the present invention;

FIG. 4 is a part of cross-sectional diagram showing the line sensor of the first exemplary embodiment of the present invention;

FIG. 5 is a schematic equivalent circuit showing a GND line of the line sensor of the first exemplary embodiment of the present invention;

FIG. 6 is a schematic equivalent circuit to review potential strain of the GND line of an output circuit of the first exemplary embodiment of the present invention;

FIG. 7 is a schematic equivalent circuit showing a GND line of a line sensor of a comparative example of the present invention;

FIG. 8 is an ideal wave form diagram in case where there is no phase shifting between CCD transfer clocks;

FIG. 9 is a wave form diagram of a comparative example in case where there is phase shifting between CCD transfer clocks;

FIG. 10 is a wave form of the first exemplary embodiment of the present invention in case where there is phase shifting between CCD transfer clocks;

FIG. 11 is a top plane pattern diagram showing a line sensor of a second exemplary embodiment of the present invention;

FIG. 12 is a part of a top plane pattern diagram showing the line sensor of the second exemplary embodiment of the present invention;

FIG. 13 is an equivalent circuit of a GND line of the line sensor of the second exemplary embodiment of the present invention; and

FIG. 14 is a top plane pattern diagram showing a line sensor of a third exemplary embodiment of the present invention.

### DETAILED DESCRIPTION OF THE EXEMPLARY EMBODIMENTS

Hereinafter, specific embodiments to which the present invention is applied will be described in detail with reference to the drawings. Note that, element of exemplary embodiments is not drawn to scale for the sake of convenience. The technical scope of the present invention should not be limitedly interpreted based on figures, because all figures are simplified. Figures are merely used for explanation of technical matters and each element shown in figures do not reflect accurate size of each element. The same components are denoted by the same reference symbols throughout the drawings, and a redundant description thereof is omitted as appropriate for clarification of the explanation. Further, the first, second and third exemplary embodiments can be combined as desirable by one of ordinary skill in the art.

### First Exemplary Embodiment

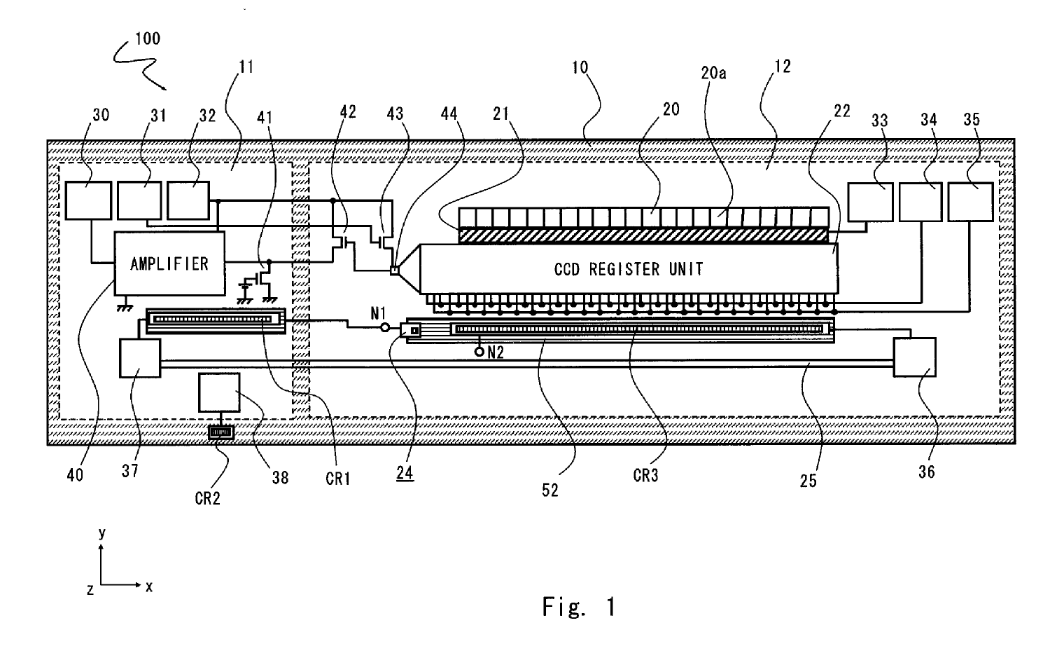

As shown in FIG. 1, a line sensor 100 includes an N type semiconductor substrate 10, a P type well region 11 and a P type well region 12. The line sensor 100 is an elongated silicon substrate having a longitudinal direction of x-axis. The well regions 11 and 12 are formed by diffusing impurities into the semiconductor substrate 10. Note that, as is clear from description below, an image region of the line sensor 100 is assigned to the well region 12. An output circuit of the line sensor 100 is assigned to the well region 11. Note that, a part of the output circuit of the line sensor 100 is formed in the well region 12.

Electrode pads 30-32, electrode pads 37 and 38, an amplifier 40 and a transistor 41 are formed in the well region 11. Note that, the electrode pad 37 connects to the well region 11 in a contact region CR1. The electrode pad 38 connects to the semiconductor substrate 10 in a contact region CR2.

Electrode pads 33-36, a pixel line (pixel array region) 20, a transfer gate part (transfer electrode array region) 21, a CCD register unit (transfer electrode array region) 22, transistors 42 and 43, and a charge detector unit 44 are formed in the well region 12. The electrode pad 36 connects to the well region 12 in a contact region CR3. Note that, the electrode pads 36, 37 and after-mentioned connecting wiring 25 form wiring part.

There is a resistor wiring 24 and a connecting wiring 25 between the well region 11 and the well region 12 in addition to a wiring included in the output circuit of the line sensor 100. Above-mentioned contact region CR1 is connected to above-mentioned contact region CR3 through the resistor wiring 24. The electrode pad 37 connects to the electrode pad 36 through the connecting wiring 25. The resistor wiring 24 includes an impurity diffusion region which functions as a resistor. The connecting wiring 25 is metal wiring and has specific impedance. This configuration prevents generation of strain of output signal waveform according to phase shifting between transfer clocks inhabit. This becomes apparent from after-mentioned description.

A relation of connection will be described first. The electrode pad 30 is connected to the amplifier 40. The electrode pad 31 is connected to a gate of the transistor 43. The electrode pad 32 is connected to the amplifier 40, a drain terminal of the transistor 42 and a drain terminal of the transistor 43. A gate terminal of the transistor 42 is connected to the charge detector unit 44. A source terminal of the transistor 42 is connected to the amplifier 40 and a drain terminal of the transistor 41. A source terminal of the transistor 43 is connected to the charge detector unit 44. A gate terminal of the transistor 41 is connected to a power supply. The amplifier 40 is grounded. The electrode pad 37 is connected to the contact region CR1 and the electrode pad 36. The contact region CR1 is connected to the contact region CR3. The electrode pad 38 is connected to the contact region CR2.

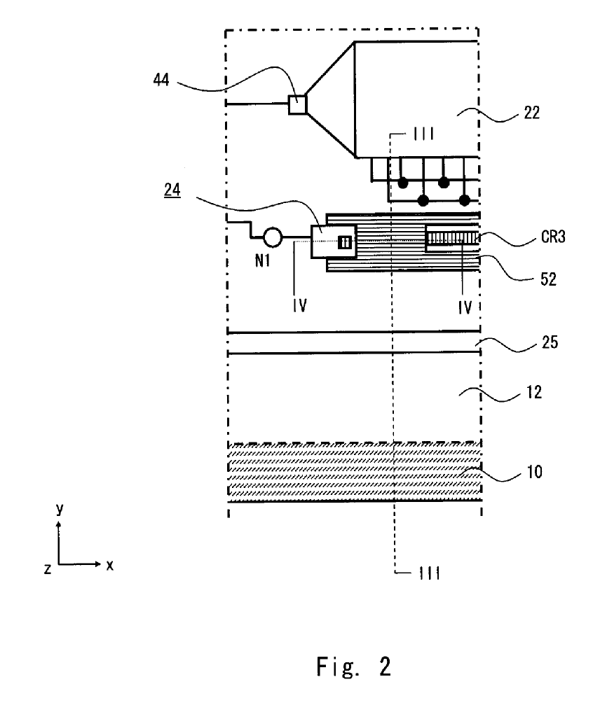

The electrode pad 33 is connected to the transfer gate part 21. The electrode pad 34 is connected to the CCD register unit 22. The electrode pad 35 is connected to the CCD register unit 22. The pixel line 20 is connected to the transfer gate part 21. The transfer gate part 21 is connected the CCD register unit 22. The CCD register unit 22 is connected to the charge detector unit 44. The electrode pad 36 is connected to the contact region CR3 and the electrode pad 37. The contact region CR3 is connected to the contact region CR1. Note that, an impurity diffusion region which functions as a resistor is formed in a connection portion between the contact region CR3 and the resistor wiring 24, and this will be described later in reference to FIGS. 2-4.

The electrode pad 30 functions as an output terminal of the amplifier 40. The electrode pad 31 functions as an input terminal of a reset signal. The electrode pad 32 functions as a voltage source terminal of amplifier and source follower. The electrode pad 33 functions as a clock terminal supplying a transfer clock into the transfer gate part 21. The electrode pad 34 functions as a clock terminal supplying a transfer clock into the CCD register unit 22. The electrode pad 35, as well as the electrode pad 34, functions as a clock terminal supplying a transfer clock into the CCD register unit 22. Note that, transfer clocks which are supplied to the electrode pads 34, 45 have opposite phase from each other. The electrode pad 36 functions as an electrode terminal which supplies GND potential to the well region 12. The electrode pad 37 functions as an electrode terminal which supplies GND potential to the well region 11. Note that, the electrode pads 36 and 37 are electrically connected mutually by the connection wiring 25. The electrode pad 38 functions as an electrode terminal which supplies a substrate potential to a semiconductor substrate 10.

The pixel line 20 includes a plurality of pixels 20a which are arranged along the x-axis. The pixels 20a function as charge accumulation part and accumulate charge depending on amount of incident light. Specifically, the pixels 20a are photodiodes formed by diffusing N type impurities into P type well region 12.

The transfer gate part 21 transfers charges accumulated in the pixels 20a to the CCD register unit 22 in synchronization with the transfer clock. The transfer gate part 21 includes a plurality of transfer electrodes formed on the well region 12 through an insulating film. Each transfer electrode corresponds to each pixel 20a. A surface potential of the well region 12 is controlled by supplying the transfer clock to the transfer electrode and electrons accumulated in the pixels 20a are transferred to the CCD register unit 22.

The CCD register unit 22 temporarily accumulates signal charges transferred from the transfer gate part 21, and supplies the signal charges to the charge detector unit 44 in series in synchronization with the transfer clock. The CCD register unit 22 includes an impurity diffusion region in which N type impurities are diffused into the well region 12and transfer electrodes formed on the impurity diffusion region through an insulating film. Each impurity diffusion region and each transfer region correspond to each pixel 20a. A channel potential of the CCD register unit 22 is controlled by supplying the transfer clock into the transfer electrode, and electrons accumulated in each pixel 20a are transferred to the charge detector unit 44 sequentially.

Note that, the transfer gate part 21 functions as a charge transfer unit which transfers charges in the y-axis direction (vertical direction). The CCD register unit 22 functions as a charge transfer unit which transfers charges in the x-axis direction (horizontal direction). The charge detector unit 44 detects charges which are transferred from the CCD register unit 22 in series. The transistor 41 functions as a load transistor. The transistor 42 functions as a drive transistor. The transistor 43 functions as a reset transistor. The charges which are detected in the charge detector unit 44 are output to the amplifier 40 as voltage signals by a circuit operation of the transistors 41-43 and the amplifier 40. Note that, an operation of the output circuit formed by these circuit elements are well known to a person having ordinary skill in the art, therefore the detailed description of the operation is omitted.

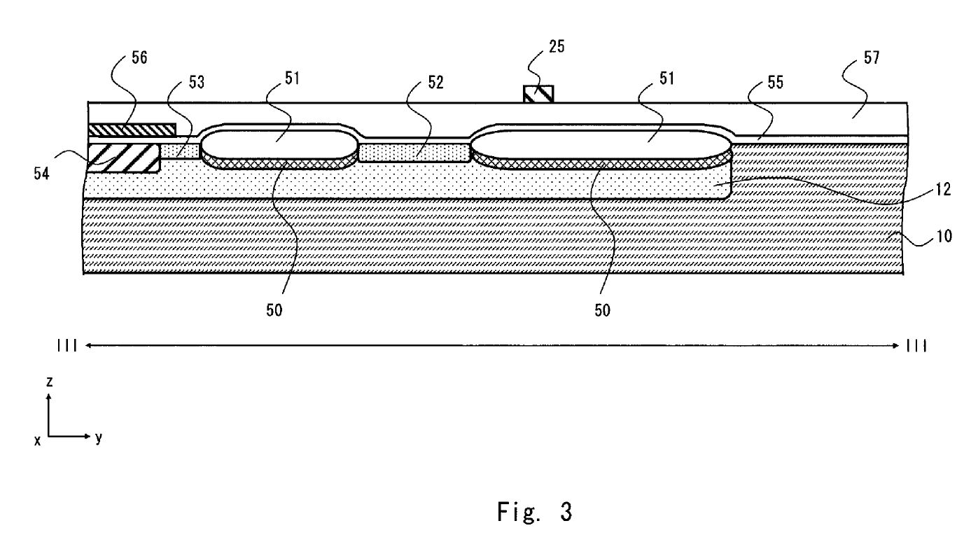

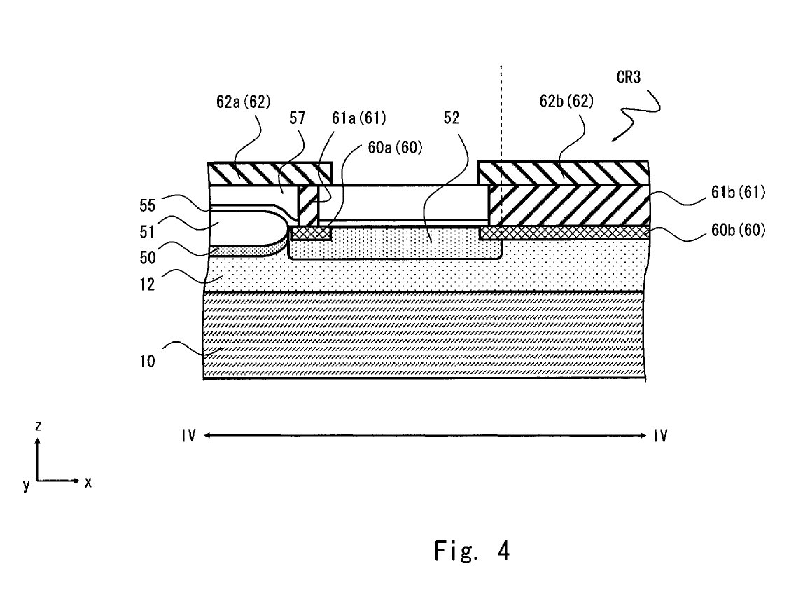

A configuration of the connection portion between above-mentioned resistor wiring 24 and the contact region CR3 will be described in reference to FIGS. 2-4. Note that, FIG. 3 is a cross-section a view between III-III of FIG. 2. FIG. 4 is a cross-sectional view between IV-IV of FIG. 2.

As shown in FIG. 3, the well region 12 is formed in the semiconductor substrate 10. An element isolation region 50, a thermally-oxide film 51, a resistor region 52, a channel stopper region 53, an N well region 54, a gate oxide film 55, a transfer electrode 56 and an interlayer insulating film 57 are formed in the well region 12. Note that, these elements are formed by a typical semiconductor process technique such as impurity injection process, thin film forming process, planarization process and overheating process and so on.

The element isolation region 50 is a region (P+ impurity diffusion region) which is formed by diffusing P-type impurities into the well region 12. The thermally-oxide film 51 is a film formed by growing SiO2 by thermal oxidation. The resistor region 52 is a region (P+ impurity diffusion region) which is formed by diffusing P-type impurities into the well region 12. The channel stopper region 53 is a region (P+ impurity diffusion region) which is formed by diffusing with P-type impurities into the well region 12. The N well region 54 is an impurity diffusion region which is formed by diffusing N-type impurities into the well region 12. The gate oxide film 55 is a SiO2 film formed by a typical thin film forming technique. The interlayer insulating film 57 is a polysilicon layer formed by a typical thin film forming technique and a patterning technique. The transfer electrode 56 is a SiO2 film formed by a typical thin film forming technique.

Note that, the well region 12 itself can be used as the resistor region 52, if a resistance value of the well region 12 is an applicable value. According to the present exemplary embodiment, as the resistance value of the well region 12 is higher than a desired value, impurities are injected to the well region 12, and the resistor region 52 which has lower resistance value is formed. The resistance value of the resistor region 52 can be any value between tens of Ω to tens of kΩ.

The resistor region 52 is formed with the same process as forming of the channel stopper region 53. This can avoid increasing of the number of the manufacturing processes of the line sensor 100 in association with introducing of new impurity diffusion region.

As shown in FIG. 4, a contact region 60 to realize ohmic contact is formed in above-mentioned resistor region 52. A contact region 60a is a high concentration impurity diffusion region (P++ impurity diffusion region) formed by injected P type impurities such as boron into the resistor region 52 in high concentration. A contact region 60b is a high concentration impurity diffusion region (P++ impurity diffusion region) formed by injecting P type impurities such as boron into the resistor region 52 and the well region 12 in high concentration. The contact region 60 is formed with the same process as source and drain regions of a transistor formed in the semiconductor substrate 10. This avoids increasing of manufacturing process of the line sensor 100. Note that, the thermally-oxide films 51 are formed adjacent to the resistor region 52.

A contact plug 61 is formed on the contact region 60. A contact plug 61a is connected to the contact region 60a. A contact plug 61b is connected to a contact region 60b. Note that, the contact plug 61 is formed by forming through-hole in the interlayer insulating film 57 and accumulating conductive material such as polysilicon into the through-hole.

A wiring 62 is formed on the contact plug 61. A wiring 62a is connected to the contact plug 61a. A wiring 62b is connected to the contact plug 61b. Note that, the wiring 62 is formed by patterning of a conductive thin film such as metal.

Note that, as shown in FIGS. 2-4, the resistor wiring 24 is formed to include the wiring 62b, the contact plug 61b, the contact region 60b, the resistor region 52, the contact region 60a, the contact plug 61a and the wiring 62a. As is clear from FIG. 4, in the contact region CR3, the wiring 62b is connected to the well region 12 through the contact plug 61b and the contact region 60b. The contact region CR1 is formed in the same way as the contact region CR3. The contact region CR2 is also formed in the same way as the contact region CR1 except that a conductive type of the contact region is opposite.

As is clear from above description, in the exemplary embodiment, the contact region CR1 is connected to the contact region CR3 through the resistor region 52. The electrode pad 37 is connected to the electrode pad 36 through the connecting wiring 25. This configuration prevents occurrence of strain in an output signal waveform according to the phase shifting between the transfer clocks. Hereinafter, this point will be described.

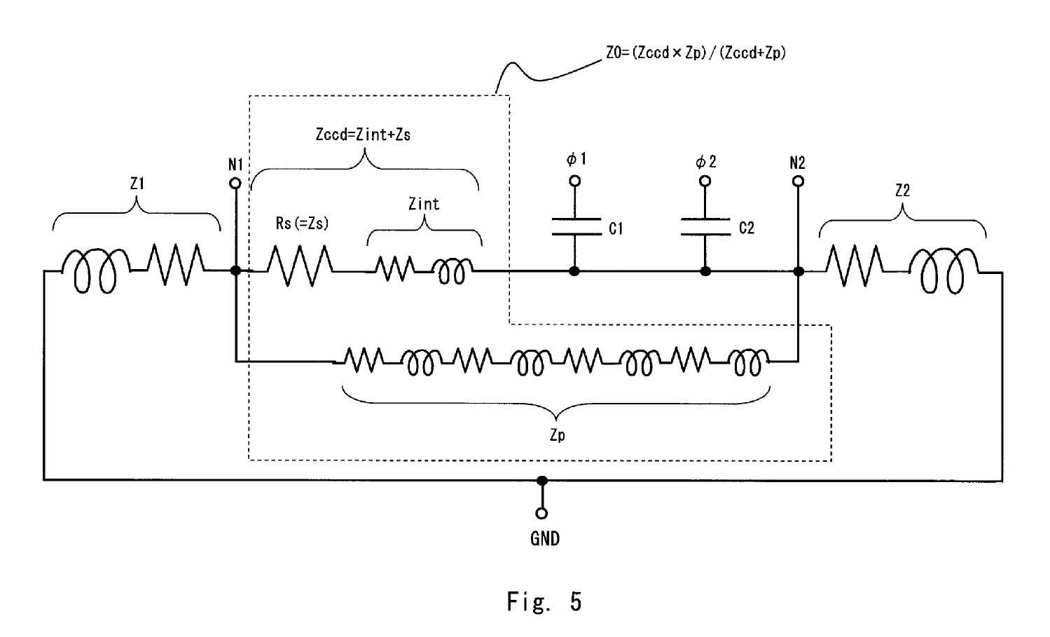

FIG. 5 is a schematic equivalent circuit showing a GND line. The resistor region 52 is shown as the resistor Rs, and has an impedance Zs. The connecting wiring 25 is connected in parallel with the resistor region 52, and has an impedance Zp. An impedance Zint corresponds to an impedance between node N1 and node N2. Note that, the node N2 is formed in the contact region CR3. An impedance Z1 is an impedance between the node N1 and ground potential. An impedance Z2 is an impedance between the node N2 and ground potential. A node supplied with a transfer clock φ1 supplied to the electrode pad 34 is connected to a node between the node N1 and the node N2 through a capacitor C1. Similarly, a node supplied with a transfer clock φ2 supplied to the electrode pad 35 is connected between the node N1 and the node N2 through a capacitor C2.

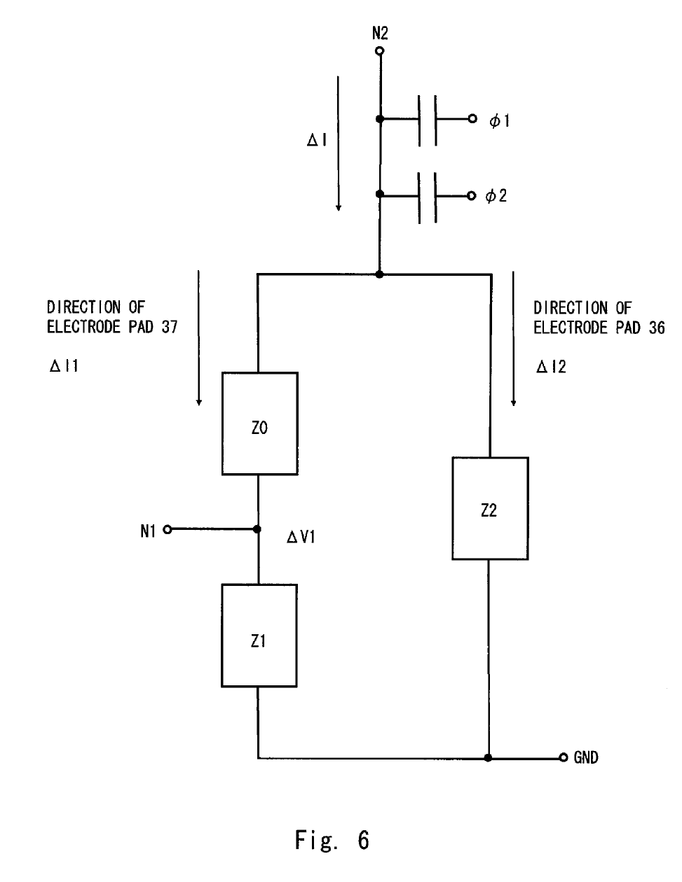

The schematic equivalent circuit of the GND line shown in FIG. 5 can be represented as FIG. 6. In FIG. 6, an amplitude ΔI of an excess current generated by the transfer clocks φ1, φ2 is separated into an amplitude ΔI1 of an excess current flowing to the electrode pad 37 and an amplitude ΔI2 of an excess current flowing to the electrode pad 36. Strain is generated in a reference potential supplied to the amplifier 40 and the transistors 41-43 by a potential strain amount ΔV1 of the node N1 shown in FIG. 5 and it causes strain in a voltage signal output from the amplifier 40.

Now reducing ΔV1 of the exemplary embodiment will be described in reference with

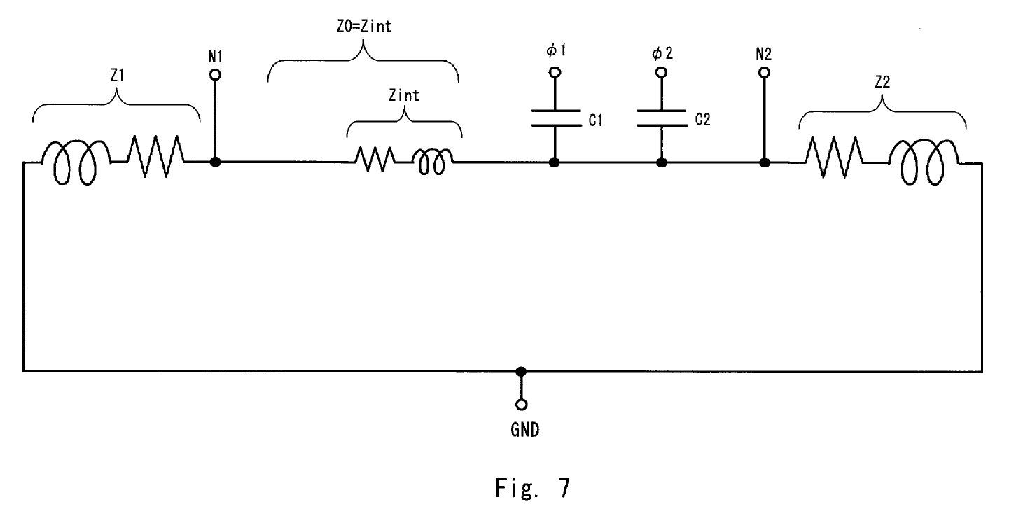

FIG. 6. The image device of Japanese Unexamined Patent Application Publication No. 6-275811 is used as comparative example. As shown in FIG. 7, the comparative example does not have a resistor Rs corresponding to the resistor region 52 and an impedance Zp corresponding to the connecting wiring 25.

As shown in FIG. 6, ΔI1 is calculated as follows.

ΔI1=ΔI×(Z2/((Z0+Z1)+Z2))

ΔV1 is represented as a next expression (1).

ΔV1=ΔI1×Z1=ΔI×((Z1×Z2)/(Z0+Z1+Z2)) (1)

First, the comparative example will be considered. Zint=Z0, so ΔV1=ΔI×((Z1×Z2)/(Zint+Z1+Z2)). Assume that an impedance between the electrode pad 36 and an external terminal of package is equal to an impedance between the electrode pad 37 and an external terminal of package, Z1=Z2=Z and ΔV1=ΔI×(Z²/(Zint+2Z) are established. If Zint <<Z is established, ΔV1≈/2×Z×ΔI=0.5×Z×ΔI is established.

Next, the exemplary embodiment will be considered. A synthetic impedance Z0 of Zccd and Zp is Z0=(Zcc×Zp)/(Zccd+Zp), and Zccd is Zccd=Zint+Zs. Assume that a resistance component Zs of the resistor region 52 is formed 100 times larger than Z1=Z2=Z, Zccd=Zint+100Z is established. Considering Zp, for example, a line sensor which has 7500 pixels, pixel pitch of 10 μm and 600 mil package is considered. In 600 mil package, the distance between an electrode pad and a lead terminal is a few millimeters, and length of a metal wiring forming Zp is 75 millimeters or more. Therefore the inductance component is about ten times larger than that of the comparative example. Further, generally, as an inside wiring resistance value is higher than an outside wiring resistance, a resistance component of an inside chip wiring is ten times larger than a resistance component of a lead terminal side. Here, if Zp=10Z, Z0=((Zint+100Z)×10Z)/((Zint+100Z)+10Z. Similarly to the comparative example, assume that Zint<<Z,Z0≈1000Z²/110Z=100/11×Z≈9Z. In this case, ΔV1 is ΔV1≈ΔI×(Z²/(9Z+Z+Z))=1/11×Z×ΔI by expression (1). This is about 18% of the comparative example.

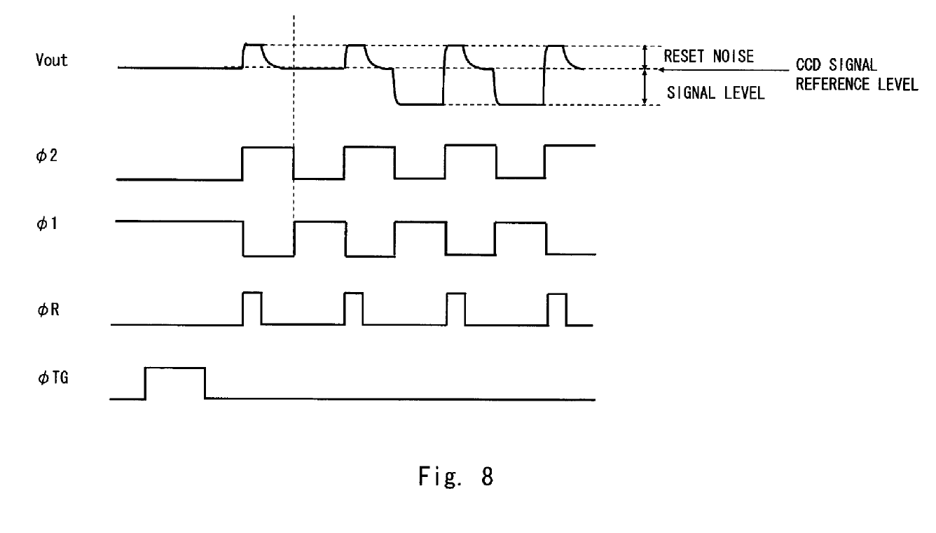

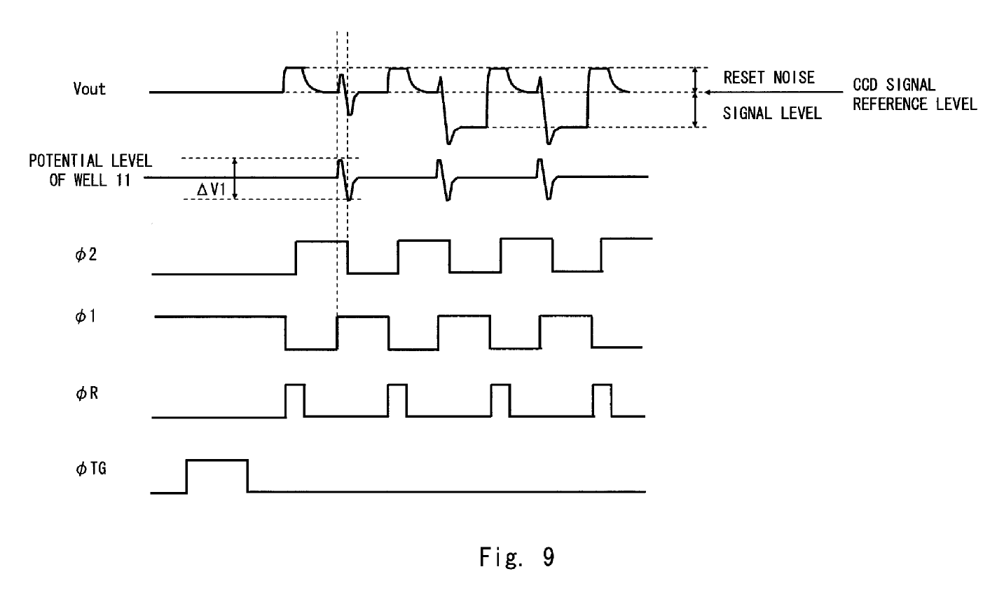

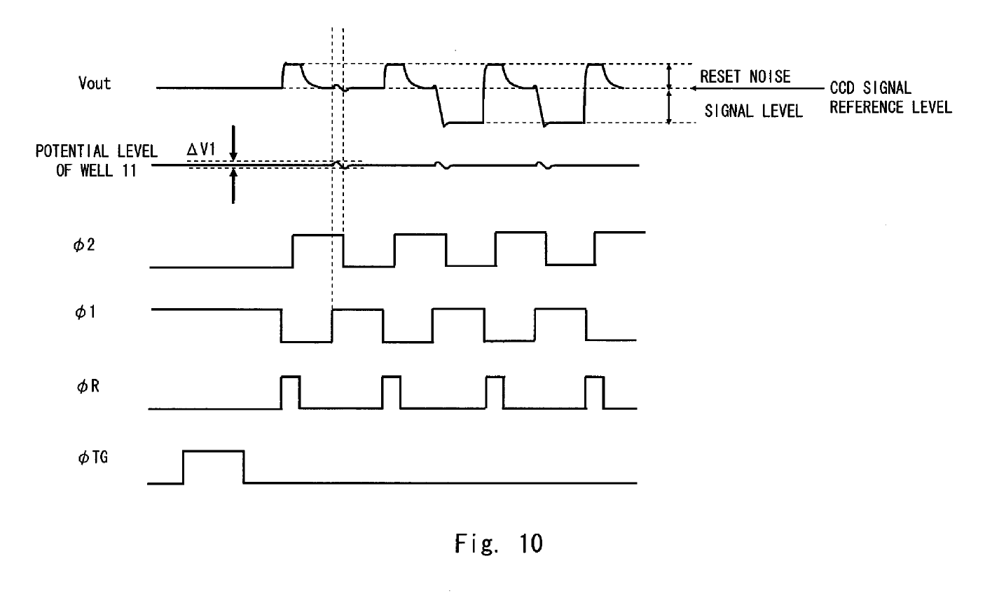

Now we describe the effect of the exemplary embodiment in reference to FIGS. 8-10. Note that, FIG. 8 shows an ideal waveform that there is no phase shifting between transfer clocks. FIG. 9 is a wave form diagram of a comparative example in case where there is phase shifting between CCD transfer clocks. FIG. 10 is a wave form of the first exemplary embodiment of the present invention in case where there is phase shifting between CCD transfer clocks.

Note that, as shown in FIG. 8, a transfer clock φTG is supplied to the transfer gate part 21 through the electrode pad 33. A reset clock φR is supplied to a gate terminal of the transistor 43 through the electrode pad 31. A transfer clock φ1 is supplied to the CCD register unit 22 through the electrode pad 35. A transfer clock φ2 is supplied to the CCD register unit 22 through the electrode pad 34. Note that, as is clear from the connection relationship of FIG. 1, the transfer clock φ1 and transfer clock φ2 are supplied to discrete transfer electrode adjacent each other. A voltage signal Vout is output from the amplifier 40, and output to outside through the electrode pad 30.

As shown in FIG. 8, in the case where there is no phase shifting between the transfer clock φ1 and the transfer clock φ2, strain is not produced in the voltage signal Vout. As will be clear from FIG. 8, the transfer gate part 21 transfers signal charge from the pixel line 20 to the CCD register unit 22 according to the transfer clock φTG. The CCD register unit 22 transfers signal charge to the charge detector unit 44 according to the transfer clocks φ1, φ2. According to the charge detection in the charge detector unit 44, the voltage signal Vout is output from the amplifier 40. The transistor 43 turns on according to the reset clock φR, and the charge detector unit 44 is reset. A reset noise is superimposed on the output signal Vout in response to above-mentioned reset operation. As shown in FIG. 8, the voltage signal Vout is output as an output signal from the pixels after the reset operation.

As shown in FIG. 9, in the comparative example, noise is superimposed on the voltage signal Vout in response to the fluctuation ΔV1 of GND potential supplied to the well region 11. On the other hand, as shown in FIG. 10, in the exemplary embodiment, as discussed previously, as the fluctuation ΔV1 is reduced, noise level superimposed on the voltage signal Vout is reduced.

As is clear from above description, in the exemplary embodiment, the contact region CR1 is connected to the contact region CR3 through the resistor region 52. Further, the electrode pad 37 is connected to the electrode pad 36 through the connecting wiring 25. This configuration can avoid generating of strain of the voltage signal Vout ouput from the amplifier 40 due to the strain generated in the GND potential due to the influence by the transfer clocks φ1, φ2.

Note that, in the exemplary embodiment, the well region 11 is electrically separated from the well region 12 by the semiconductor substrate 10. This can prevent hot carrier generated in the transistor 41 from reaching the pixels 20a, thereby reducing dark output.

Further, in the exemplary embodiment, the electrode pad 36 and the electrode pad 37 are connected by the connecting wiring 25. Thus, supply of the GND potential to the well region 11 and to the well region 12 can be made common It is possible to prevent generation of strain of a voltage signal Vout output from the amplifier 40 due to the strain generated in the GND potential due to the influence of the transfer clocks φ1, φ2, as GND potential is supplied to separately to well regions 11, 12. However, in this case, it is necessary to take measure to prevent static electricity or enhance standard limitation of voltage separately for each of the well regions 11 and 12. In some cases, the size of the line sensor 100 or peripheral circuits may be increased. In the first exemplary embodiment, as described above, the electrode pad 36 and the electrode pad 37 are connected by the connection wiring 25. Hence, the above-described problem can be effectively suppressed.

Further, in the exemplary embodiment, the connecting wiring 25 is formed along x-axis direction and has sufficient length along the x-axis as is similar to the pixel line 20, and wiring resistance value and inductance are generated as parasitic impedance like distributed constant. The inductance of the connecting wiring 25 is larger than inductances of a bonding wire and lead frame which connect the line sensor 100 and external terminals of the package by one digit. As potential strain generated in the GND line is absorbed sufficiently by a path (from an electrode pad to an external terminal of a package) whose impedance is small, even if the connecting wiring 25 connects the electrode pad 36 and the electrode pad 37, it can avoid generation of strain of the voltage signal Vout output from the amplifier 40 by strain generated in the GND potential due to the influence of the transfer clocks φ1, φ2.

Note that, the length of the connecting wiring 25 along x-axis direction is longer than that of the pixel line 20 and the CCD register unit 22 along x-axis direction. Further, the electrode pad 37 is formed in one end of the connecting wiring 25 and the electrode pad 36 is formed in the other end of the connecting wiring 25.

### Second Exemplary Embodiment

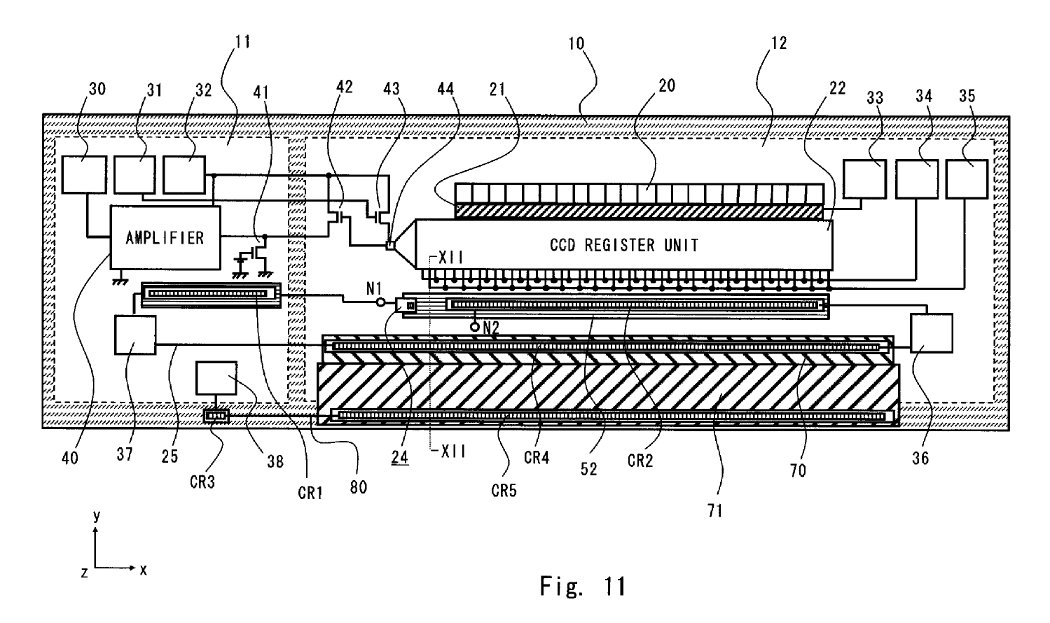

Now the second exemplary embodiment of the present invention will be described with reference to FIGS. 11-13. In the present exemplary embodiment, one end of the capacitor having the other end connected to the semiconductor substrate 10 is connected to the connecting wiring 25, and an RLC filter is connected to the resistor region 52 in parallel in addition to the configuration of the first exemplary embodiment. A low pass action of the RLC filter makes the value of ΔV1 smaller than that of the first exemplary embodiment as we discuss later. This can achieve the same effect as the first exemplary embodiment more effectively than the first exemplary embodiment.

As shown in FIG. 11, the connecting wiring 25 is connected to an opposite wiring 70 in a contact region CR4. A wiring 80 connected to the contact region CR3 is connected to an opposite wiring 71 in a contact region CR5.

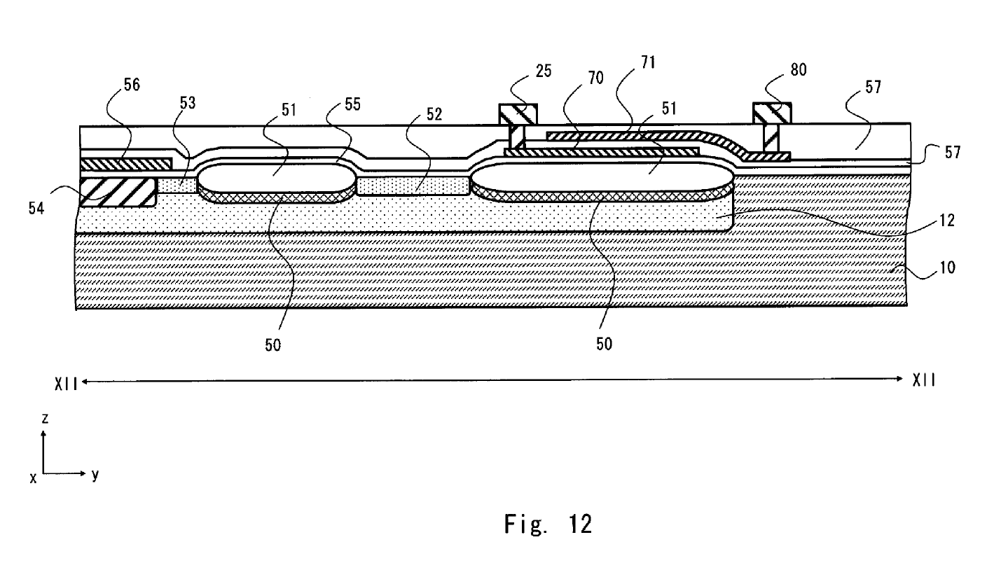

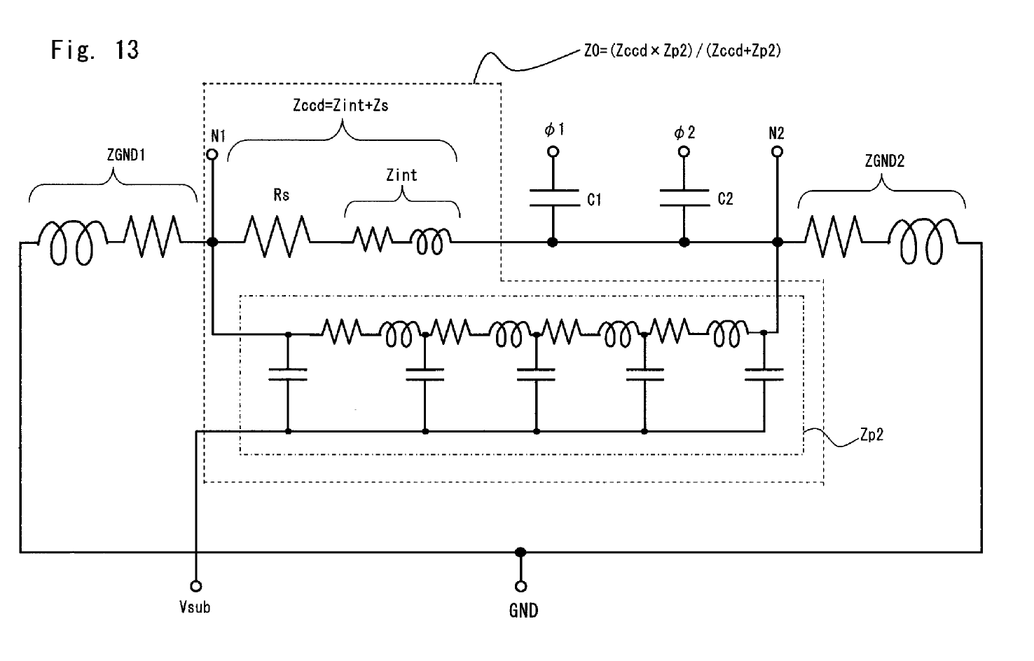

The opposite wirings 70, 71 are a wiring layer formed along X axis as is similar to the connecting wiring 25. As shown in FIG. 12, the opposite wirings 70 and 71 are laminated through an interlayer insulating film 57. Thus, a capacitor is formed by the opposite wirings 70 and 71. The opposite wiring 70 is connected to the connecting wiring 25 through a plug. Similarly, the opposite wiring 71 is connected to the wiring 80 through a plug. The capacitor formed by the opposite wirings 70, 71 has capacitor component configuring impedance Zp2 of FIG. 13. Note that, FIG. 12 is a cross-sectional view of XII-XII of FIG. 11 corresponding to FIG. 3.

The RLC filter includes frequency characteristics of low pass. Assuming that frequency is f and angular frequency is ω=2πf, its gain G as follows.

G=1/√((1−ω²LC)²+(ωRC)²)

Frequency domain in which potential strain fluctuation occurs can be cut by sufficiently increasing the value of the capacitor C by sufficiently acquiring opposite area between the opposite wirings 70 and 71. In this case, Z0 in the expression (1) is assumed as follows.

Zo=Zccd=(Zint+Zs)

As is similar to well as the first exemplary embodiment, if it is assumed that Z=Z1=Z2, Zs=100Z, and Zint<<Z, ΔV1≈ΔI×(Z²/(100Z+Z+Z))=1/102×Z×ΔI by the expression (1). That is, ΔV1 is further decreased than the first exemplary embodiment and it is suppressed to 2% compared the comparative example.

### Third Exemplary Embodiment

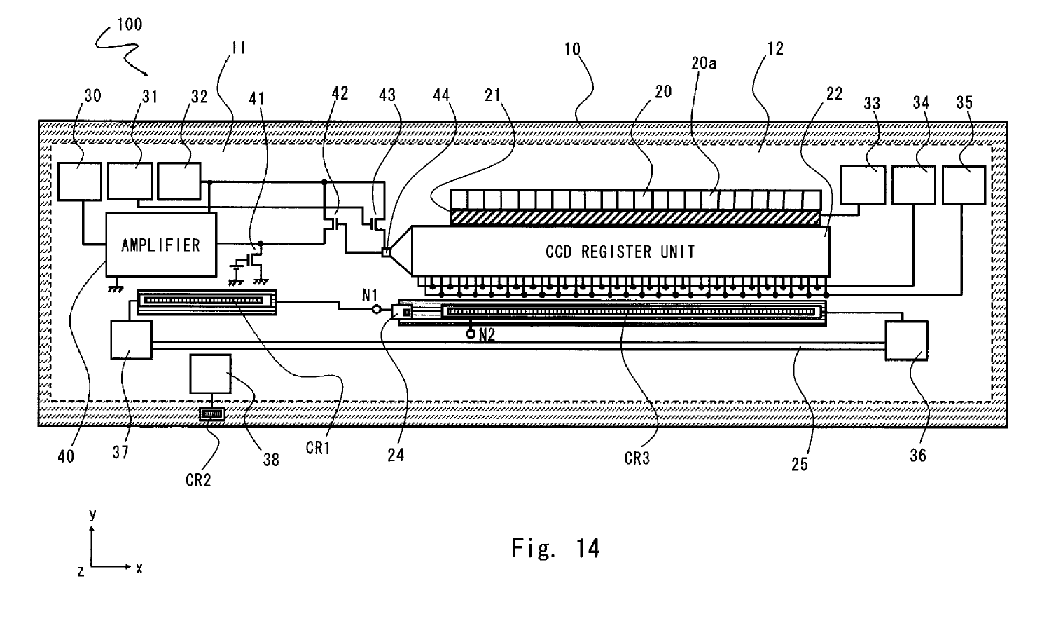

Now the third exemplary embodiment of the present invention will be described with reference to FIG. 14. The present exemplary embodiment is different from the first exemplary embodiment, in that the well regions 11 and 12 are formed as a common well region. Even in this case the same effect as the first exemplary embodiment can be achieved.

It is apparent that the present invention is not limited to the above exemplary embodiments but may be modified and changed without departing from the scope and spirit of the invention. For example, the present invention may be applied to an area sensor, instead of the line sensor. Further, the present invention may be applied to a CMOS imager, instead of the CCD imager. Furthermore, a part of an output circuit can be formed in another chip, and the output circuit and the CCD imager are not always completely integrated perfectly.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A semiconductor image device comprising:
a second conductive type semiconductor substrate where a first conductive type well region is formed;
a pixel arranged region formed in the well region, a plurality of pixels being formed on the well region, the plurality of pixels generating charges corresponding to an incident light;
a transfer electrode arranged region formed on the well region, a transfer electrode being arranged on the well region, the transfer electrode transferring the charges in response to a transfer clock;
an output circuit which outputs a voltage signal corresponding to the charges transferred by the transfer electrode;
a wiring part which supplies a reference potential to the well region and the output circuit; and
a resistor which is included in a wiring, the wiring connecting a first contact between the well region and the wiring part to a second contact between the output circuit and the wiring part.

2. The semiconductor image device according to claim 1, wherein the resistor is an impurity diffusion region formed by diffusing impurities into the well region.

3. The semiconductor image device according to claim 1, wherein the wiring part includes a part extended along a transfer direction of the charges in the transfer electrode arranged region.

4. The semiconductor image device according to claim 2, wherein the wiring part includes a part extended along a transfer direction of the charges in the transfer electrode arranged region.

5. The semiconductor image device according to claim 1, wherein the wiring part comprising:
a first electrode pad which corresponds to the well region;
a second electrode pad which corresponds to the output circuit; and
a connecting wiring which connects the first electrode pad with the second electrode pad.

6. The semiconductor image device according to claim 2, wherein the wiring part comprising:
a first electrode pad which corresponds to the well region;
a second electrode pad which corresponds to the output circuit; and
a connecting wiring which connects the first electrode pad with the second electrode pad.

7. The semiconductor image device according to claim 3, wherein the wiring part comprising:
a first electrode pad which corresponds to the well region;
a second electrode pad which corresponds to the output circuit; and
a connecting wiring which connects the first electrode pad with the second electrode pad.

8. The semiconductor image device according to claim 5, wherein the connecting wiring is extended along a transfer direction of the charges of the transfer electrode arranged region, the first electrode pad is formed at one end side of the connecting wiring, and the second electrode pad is formed at the other end side of the connecting wiring.

9. The semiconductor image device according to claim 8, further comprising a first opposite wiring which connects to the semiconductor substrate and is arranged opposite to the connecting wiring in a width direction of the semiconductor substrate.

10. The semiconductor image device according to claim 9, further comprising a second opposite wiring which connects to the connecting wiring and is arranged opposite to the first opposite wiring.

11. The semiconductor image device according to claim 10, wherein the first opposite wiring and the second opposite wiring are extended along the transfer direction of the charger in the transfer electrode arranged region.

12. The semiconductor image device according to claim 1, wherein the output circuit includes a transistor formed in the well region formed on the semiconductor substrate.

13. The semiconductor image device according to claim 12, wherein a contact of the wiring part to the output circuit is a contact of the wiring part to the well region where the transistor is formed.

14. The semiconductor image device according to claim 12, wherein the well region where the transistor is formed is common to the well region where the plurality of pixels are formed.

15. The semiconductor image device according to claim 13, wherein the well region where the transistor is formed is common to the well region where the plurality of pixels are formed.
